(19) United States
(12) Patent Application Publication
(10) Pub. No.: US 2011/0070449 A1
(43) Pub. Date: Mar. 24, 2011

(54) A COMPOSITE MATERIAL, THE METHOD FOR PREPARING THE SAME AND THE USE THEREOF

(75) Inventors: Yurun Yang, Shanghai (CN); Yong Dong Pang, Shanghai (CN); Chun Hua Zhang, Shanghai (CN)

(73) Assignee: Bayer MaterialScience AG

(21) Appl. No.: 12/992,521

(22) PCT Filed: May 2, 2009
(86) PCT No.: PCT/EP2009/003165

§ 371 Date: Nov. 12, 2010

(30) Foreign Application Priority Data
May 14, 2008 (CN) 2008 1 0037375.X

(51) Int. Cl. B32B 27/40; B05D 1/36; B32B 27/38

(52) U.S. Cl. 428/414; 427/407.1; 428/424.4

(57) ABSTRACT

The present invention pertains to a composite material, the method for preparing the same and the use thereof. In this invention, the surface of the polyacrylate layer is treated by silane or silane solution during the process for preparing the composite material to improve the adhesion strength between the polyacrylate layer and the polyurethane layer.

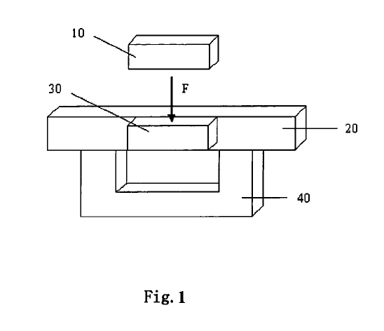

### TECHNICAL FIELD

The present invention pertains to the field of polyurethane, especially a composite material comprising polyurethane and polyacrylate.

### BACKGROUND

Thermoplastic materials (such as polyacrylate) can be used to make thin shell products. To improve the pressure resistance and load-bearing intensity, polyurethane materials are normally used to enhance the structure of this thin shell product from the backside, thus the composite material comprising thermoplastic materials and polyurethane materials possesses the features of lightness and firmness, the composite material can not only be used to make bathtub, shower plate, but also be used to make the parts of automobile, the parts of ship, sports equipment, the parts of aerospace, the parts of aviation, etc. However, the composite material is easy to delaminate, deform and desquamate, due to the fact that the poor adhesion between the thermoplastic materials and the polyurethane.

There are many methods can be used to improve the adhesion strength between the thermoplastic materials and the polyurethane. For example, U.S. Pat. No. 6,967,101, U.S. Pat. No. 4,957,603 and U.S. Pat. No. 6,156,394 disclosed that, the surface of the polyacrylate is treated by oxygen plasma and argon plasma to improve the adhesion strength between the polyacrylate and the polyurethane during the manufacture of lens. However, this method can not be applied widely in the field of composite material because of the high cost. Furthermore, WO2003047857 and WO9948933 disclosed that the adhesion characteristics of the hard bonding plastics can be improved by ways of surface corona treatment, flame treatment, ionization radiation, vacuum deposition treatment, oxidant surface abrasion treatment, etc. Nevertheless, these methods are complicated and costly.

Therefore, from an industrial point of view, it is necessary to find an economical and facilitated method to improve the adhesion characteristics of the thermoplastic material and polyurethane material to overcome the problems of delaminating, deformation and desquamation existed in the filed of composite material.

### CONTENTS OF INVENTION

The objective of this invention is to provide a composite material comprising a polyacrylate layer, a polyurethane layer and a silane layer, wherein, the silane layer lies between the polyacrylate layer and the polyurethane layer.

Another objective of this invention is to provide a process for preparing the composite material, comprising the steps of spreading the silane layer onto a surface of the polyacrylate layer and spreading a polyurethane reaction system onto the surface of the polyacrylate layer with the silane layer spread thereon to form the polyurethane layer.

Another objective of this invention is to provide an application of the composite material in preparing bath products, automobile parts, ship parts, sport equipments, spaceflight parts and aviation parts.

The advantages of this invention are that the composite material and the preparation thereof provided in this invention could significantly improve the adhesion between the polyacrylate layer and the polyurethane layer of the composite material. By this method, the composite material is not easy to be delaminated, distorted and flaked off. Therefore, the composite material is suitable for many applications.

### DRAWING DESCRIPTION

Drawing 1 is a sketch map for a testing of the adhesion strength and the cohesion destructiveness between the polyacrylate layer and the polyurethane layer of the composite material provided in this invention.

### MODE OF CARRYING OUT THE INVENTION

The composite material provided in this invention comprises a polyacrylate layer, a polyurethane layer and a silane layer, wherein, the silane layer lies between the polyacrylate layer and the polyurethane layer.

The silane layer comprises one or more silanes. The silane has a general formula of Y—R—Si-MeₙX₃₋ₙ, where, Y is an isocyanurate group, methacryloxy group or epoxy group, R is an alkyl group comprising 1-5 carbon atoms, Me is methyl, n=1-3, and X is methoxy (OCH₃), ethoxy (OC₂H₅), isopropoxide (OCH₂(CH₃)₂) or 2-methoxyethoxy (OCH₃OC₂H₄). The silane can be selected from, but not limited to, isocyanurate silane, methacryloxy silane, epoxy silane and the mixtures thereof.

The isocyanurate silane can be selected from, but not limited to, tri-((3-trimethoxy silicon) propyl) isocyanurate, tri-((3-triethoxy silicon) propyl) isocyanurate and the mixtures thereof.

The methacryloxy silane can be selected from, but not limited to, γ-methacryloxy propyl trimethoxy silane, γ-methacryloxy propyl methyl dimethoxy silane, γ-methacryloxy propyl triethoxy silane, γ-methacryloxy propyl methyl diethoxy silane, γ-methacryloxy propyl triisopropoxide silane, γ-methacryloxy propyl tri(2-methoxyethoxy) silane and the mixtures thereof.

The epoxy silane can be selected from, but not limited to, γ-glycidoxypropyl trimethoxy silane, γ-glycidoxypropyl triethoxy silane, γ-glycidoxypropyl triisopropoxide silane, γ-glycidoxypropyl methyl dimethoxy silane, γ-glycidoxypropyl methyl diethoxy silane, β-(3,4-epoxy cyclohexyl)ethyl trimethoxy silane, and β-(3,4-epoxy cyclohexyl)ethyl triethoxy silane and the mixtures thereof.

In this invention, the polyacrylate layer comprises one or more polyacrylates. The polyacrylate could be selected from, but not limited to, polymethyl methpolyacrylate, poly ethyl methpolyacrylate, poly butyl methpolyacrylate, polymethyl polyacrylate, polyethylene polyacrylate and poly butyl polyacrylate. Optionally, filler and additive can be added into the polyacrylate. The filler can be selected from, but not limited to, calcium carbonate, titanium dioxide, talcum powder and barium sulfate. The additive can be selected from, but not limited to, ultraviolet stabilizer and plasticizer. The polyacrylate layer can comprise one or more polyacrylate materials selected from the group of polyacrylate materials, polyacrylate blend and copolymerization modified polyacrylate materials.

In this invention, the polyurethane layer comprises one or more polyurethane. The polyurethane can be selected from, but not limited to, polyether polyurethane, polyester polyurethane and polyolefin polyurethane.

The polyurethane is a reaction product of a polyurethane reaction system. The polyurethane reaction system comprises polyisocyanates, polyols and chain extender.

The polyisocyanate can be selected from, but not limited to, alicyclic polyisocyanate, aromatic polyisocyanate, their modifier and the mixtures thereof. The modifier can be selected from, but not limited to, biuret, isocyanurate, allophanate, isocyanate prepolymer and the mixtures thereof. The iso prepolymer is isocyanate-terminated prepolymer obtained by the reaction of polyisocyanates and other compounds, the isocyanate prepolymer can be selected from, but not limited to, the isocyanate prepolymer obtained by the reaction of polyisocyanates and polyols.

The polyisocyanates can be selected from, but not limited to, ethylene diisocyanate, 1,4-tetramethylene diisocyanate, 1,6-hexamethylene diisocyanate, 1,12-dodecane diisocyanate, cyclobutane-1,3-diisocyanate, cyclohexane-1,3-diisocyanate, cyclohexane-1,4-diisocyanate, the mixtures of cyclohexane-1,3-diisocyanate and cyclohexane-1,4-diisocyanate, isophorone diisocyanate 2,4-hexahydro-toluene diisocyanate, 2,6-hexahydro-toluene diisocyanate, the mixtures of 2,4-hexahydro-toluene diisocyanate and 2,6-hexahydro-toluene diisocyanate, dicyclohexylmethane-4,4′-diisocyanate (H12MDI), 2,4-toluene diisocyanate (2,4-TDI), 2,6-toluene diisocyanate (2,6-TDI), the mixtures of 2,4-toluene diisocyanate and 2,6-toluene diisocyanate, diphenylmethane-2,4′-diisocyanate (2,4-MDI), diphenylmethane-4,4′-diisocyanate (4,4-MDI), the mixtures of diphenylmethane-2,4′-diisocyanate and diphenylmethane-4,4′-diisocyanate, polyphenyl polymethylene polyisocyanates (so called crude MDI or PAPI), norbornane diisocyanate, m-isocyanatophenyl sulfonylisocyanate, p-isocyanatophenyl sulfonylisocyanate and the mixtures thereof.

The polyisocyanates can also include modified polyisocyanates containing carbodiimide groups, modified polyisocyanates containing carbodiimide groups, modified polyisocyanates containing isocyanurate groups, modified polyisocyanates containing urethane groups, modified polyisocyanates containing allophanate, modified polyisocyanates containing urea groups, polyisocyanates containing biuret groups, polyisocyanates containing ester groups, polyisocyanates containing polymeric fatty acid groups, reaction products of the above-mentioned isocyanates with acetals and the mixtures thereof.

The average functionality of the polyols is 1.8-8, preferably 2-6, the molecular weight of the polyols is 300-8000, preferably 400-4000. The polyols can be selected from, but not limited to, polyether polyols, polyester polyols, polymer polyols, polycarbonate polyols, polyolefin polyols, the mixtures thereof, preferably, polyether polyols, polyester polyols and the mixtures thereof.

The polyether polyols can be made by the process known in the prior arts, for example, made by the reaction between olefin dioxide and starting agent at the present of catalyst. The catalyst can be selected from, but not limited to, alkaline hydroxide, alkaline alkoxide, antimony pentachloride, boron fluoride ether and the mixtures thereof. The alkaline hydroxide can be selected from, but not limited to, tetrahydrofuran, ethylene oxide, 1,2-propylene oxide, 1,2-epoxy butane, 2,3-epoxy butane, styrene oxide, epichlorohydrin and the mixtures thereof. The starting agent can be selected from, but not limited to, active hydrogen compounds, the active hydrogen compounds can be selected from, but not limited to, water, ethylene glycol, 1,2-propylene glycol, 1,3-propylene glycol, diethylene glycol, trimethylolpropane, sucrose, sorbitol, aniline, ethanol ammonia, ethylenediamine and the mixtures thereof.

The polyester polyols can be made by the reaction of dicarboxylic acids or dicarboxylic acid anhydrides with polyols. The dicarboxylic acid can be selected from, but not limited to, aliphatic carboxylic acids containing 2 to 12 carbon atoms, the unlimited examples are succinic acid, malonic acid, glutaric acid, adipic acid, suberic acid, azelaic acid, sebacic acid, dodecyl carboxylic acid, maleic acid, fumaric acid, phthalic acid, isophthalic acid, terephthalic acid and the mixtures thereof. The dicarboxylic acid anhydride can be selected from, but not limited to, phthalic anhydride, tetrachlorophthalic anhydride, maleic anhydride and the mixtures thereof. The polyol can be selected from, but not limited to, glycol, diethylene glycol, 1,2-propanediols, 1,3-propanediols, dipropylene glycol, 1,3-methylpropanediol, 1,4-butanediol, 1,5-pentanediol, 1,6-hexanediol, neopentyl glycol, 1,10-decandediol, glycerol, trimethylol-propane and the mixtures thereof.

The polymer polyols, made by the process known in the prior arts, for example, made by the reaction between styrene and acrylonitrile at the present of polyether. The polyether can be selected from, but not limited to, polyoxypropylene polyether without ethylene oxide unit.

The polycarbonate polyols can be selected from, but not limited to, polycarbonate diols. The polycarbonate diols can be made by the reaction of diols and dialkyl carbonate or diaryl carbonate or phosgene. The diols can be selected from, but not limited to, 1,2-propanediol, 1,3-propanediol, 1,4-butanediol, 1,5-pentanediol, 1,6-hexanediol, diethylene glycol, trioxanediol and the mixtures thereof. The dialkyl carbonate or diaryl carbonate can be selected from, but not limited to, diphenyl carbonate.

The polyolefin polyols can be selected from, but not limited to, hydroxyl-terminated polybutadiene, hydroxyl-terminated polystyrene butadiene copolymer, hydroxyl-terminated polypropylene butadiene copolymer and the mixtures thereof.

The chain extender, is typically selected from the active hydrogen atom containing compound having a molecular weight <800, preferably 18-400. The active hydrogen atom containing compound can be selected from, but not limited to, alkanediols, dialkylene glycols, polyols and the mixtures thereof, the unlimited examples are glycol, 1,4-butanediol, 1,6-hexanediol, 1,7-heptanediol, 1,8-octanediol, 1,9-nonanediol, 1,10-decanediol, diethylene glycol, dipropylene glycol, polyoxyalkylene glycols and the mixtures thereof. The active hydrogen atom containing compound can also include other branched chain or unsaturated alkanediols, the unlimited examples are 1,2-propanediol, 2-methyl-1,3-propanediol, 2,2-dimethyl-1,3-propanediol, 2-butyl-2-ethyl-1,3-propanediol, 2-butene-1,4-diol, 2-butyne-1,4-diol, alkanolamines, N-alkyldialkanolamines and the mixtures thereof; the N-alkyldialkanolamines can be selected from, but not limited to, ethanolamine, 2-aminopropanol and 3-amino-2,2-dimethylpropanol, N-methyl, N-ethyldiethanolamine and the mixtures thereof. The active hydrogen atom containing compound can further include aliphatic amines, aromatic amines and the mixtures thereof, the unlimited examples are 1,2-ethylenediamine, 1,3-propylenediamine, 1,4-butylenediamine, 1,6-hexamethylenediamine, iso, 1,4-diaminocyclohexane, N,N′-diethyl-phenylenediamine, 2,4-diaminotoluene, 2,6-diaminotoluene and the mixtures thereof.

The components for preparing the polyurethane can further include blowing agent, catalyst, and optionally additive.

The blowing agent can be selected from, but not limited to, water, halohydrocarbon, hydrocarbon and gas. The halohydrocarbon can be selected from, but not limited to, monochlorodifluoromethane, dichloromonofluoromethane, dichlorofluoromethane, trichlorofluoromethane and the mixtures thereof. The hydrocarbon can be selected from, but not limited to, butane, pentane, cyclopentane, hexane, cyclohexane, heptane and the mixtures thereof. The gas can be selected from, but not limited to, air, CO₂, N₂ and the mixtures thereof.

The catalyst can be selected from, but not limited to, amine catalysts, organometallic catalysts and the mixtures thereof.

The amine catalysts can be selected from, but not limited to, tertiary amine catalysts. The tertiary amine catalysts can be selected from, but not limited to, dabco, triethylamine, tributylamine, N-ethylmorpholine, N,N,N′,N′-tetramethyl-ethylenediamine, pentamethyldiethylenetriamine, N,N-methylbenzylamine, N,N-dimethylbenzylamine and the mixtures thereof.

The organometallic catalysts can be selected from, but not limited to, organo-tin compounds. The organo-tin compounds can be selected from, but not limited to, organo tin carboxylate, dialkyl tin (IV) salt and the mixtures thereof. The organo tin carboxylate can be selected from, but not limited to, tin (II) acetate, tin (II) octoate, ethylhexonate tin, laurate tin, dibutyltin oxide, dibutyltin dichloride, dibutyltin diacetate, dibutyltin maleate, dioctyltin diacetate and the mixtures thereof. The dialkyl tin (IV) salt can be selected from, but not limited to, dibutyltin diacetate, dibutyltin dilaurate, dibutyltin maleate, dioctyltin diacetate and the mixtures thereof.

The additive can be selected from, but not limited to, reinforced fiber, pigment, surfactant, stabilizer and filler.

The reinforced fiber can be selected from, but not limited to, natural fiber, artificial fiber and the mixtures thereof. The natural fiber can be selected from, but not limited to, flax fiber, jute fiber, sisal fiber, mineral fiber and the mixtures thereof. The artificial fiber can be selected from, but not limited to, polyamide fiber, polyester fiber, carbon fiber, polyurethane fiber, glass fiber and the mixtures thereof.

The surfactant can be selected from, but not limited to, polyoxyalkylene derivatives of siloxane.

The stabilizer can be selected from, but not limited to, antioxidant, ultraviolet stabilizer and the mixtures thereof.

The filler can be selected from, but not limited to, glass slice, mica, barium sulfate, calcium carbonate, talcum powder and the mixtures thereof.

The method for preparing the composite material provided in this invention comprises steps of: spreading the silane layer onto a surface of the polyacrylate layer and spreading a polyurethane reaction system onto the surface of the polyacrylate layer with the silane layer spread thereon to form the polyurethane layer.

According to the method, the silane or the silane solution can be, but not limited to, spread onto the surface of the polyacrylate layer to form the silane layer by way of spraying, brush coating or wiping.

The silane possesses a general formula of Y—R—Si-MeₙX₃₋ₙ, where, Y is an isocyanurate group, methacryloxy group or epoxy group, R is an alkyl group comprising 1-5 carbon atoms, Me is methyl, X is methoxy (OCH₃), ethoxy (OC₂H₅), isopropoxide (OCH₂(CH₃)₂) or 2-methoxyethoxy (OCH₃OC₂H₄). The silane can be selected from, but not limited to, isocyanurate silane, methacryloxy silane, epoxy silane and the mixtures thereof.

The solute of the silane solution comprises one or more silanes having a general formula of Y—R—Si-MeₙX₃₋ₙ, where, Y is an isocyanurate group, methacryloxy group or epoxy group, R is an alkyl group comprising 1-5 carbon atoms, Me is methyl, X is methoxy (OCH₃), ethoxy (OC₂H₅), isopropoxide (OCH₂(CH₃)₂) or 2-methoxyethoxy (OCH₃OC₂H₄). The silane can be selected from, but not limited to, isocyanurate silane, methacryloxy silane, epoxy silane and the mixtures thereof.

The solvent of the silane solution is selected from the group of alcoholic solvent, ketone solvent, and ester solvent and the mixtures thereof.

The concentration of the silane solution is 0.5-20 wt. %, more preferably is 1-10 wt. %, most preferably is 2-5 wt. % based on 100 wt. % of the silane solution

According to the method provided in this invention, the polyurethane reaction system can be, but not limited to, spraying onto the surface of the polyacrylate layer, on which is spread a silane layer, to form the polyurethane layer.

### EXAMPLES

In the present invention, the following method was used to test the adhesion strength and cohesion failure percentage between the polyacrylate layer and the polyurethane layer:

A bending-shearing method was used to test the adhesion strength and cohesion failure percentage between the polyacrylate layer and the polyurethane layer, wherein the polyacrylate layer and the polyurethane layer was pretreated by the silane or silane solution. The detailed method was shown in Drawing 1.

A sample of the composite material provided in this invention includes a polyurethane layer 20 and a polyacrylate layer 30. The sample was put on a support 40, a force was brought to bear on the polyacrylate layer 30 by a rectangle compression bar 10. The force was brought to bear on the sample and tracked recording by the rectangle compression bar 10, wherein the flow rate of the rectangle compression bar 10 was 5 mm/min, until the adhesion between the polyurethane layer 20 and the polyacrylate layer 30 was destroyed.

By checking the destroyed interface, it was not a cohesion failure, if the destroy was completely taken place on the polyurethane layer 20 and the polyacrylate layer 30, in this case, the cohesion failure percentage was recorded as 0%. If the destroy was completely taken place in the polyurethane layer 20 or the polyacrylate layer 30, the cohesion failure percentage was recorded as 100%. If the aforementioned situations were taken place at the same time, the cohesion failure percentage was recorded in accordance with the percentage of destroying area in any layer, based on the 100% of total destroying area.

In the whole proceeding, the force value, which was recoded when the adhesion was destroyed, and the cohesion failure percentage were used to value the adhesion property between the polyurethane layer and the polyacrylate layer.

This testing method could be run by any testing apparatus possessed suitable range of force load.

Description of the Raw materials mentioned thereinbefore and thereinafter:
Multitec® TP.PU. 20MT08: blending of polyols, available from Bayer;
Multitec® TP.PU. 20MT11: blending of polyols, available from Bayer;
Multitec® TP.PU. 10MT03: isocyanate prepolymer, available from Bayer;
A-189: γ-sulfhydryl propyl trimethoxyl silane, available from Momentive Performance Materials;
A-1100: γ-aminopropyl triethoxy silane, available from Momentive Performance Materials;
A-1524: γ-ureido propyl trimethoxy silane, available from Momentive Performance Materials;
A-174: γ-methyl propylene acyloxy propyl trimethoxyl silane, available from Momentive Performance Materials;
A-171: vinyl trimethoxyl silane, available from Momentive Performance Materials;
A-Link 597: tri-((3-trimethoxy silane) propyl) isocyanurate, available from Momentive Performance Materials;
A-187: γ-glycidyl ether oxypropyl trimethoxy silane, available from Momentive Performance Materials;
Unipre CP54: polyurethane low pressure spraying equipment, available from Unipre.

### Example 1

A dry cloth was used to rub the surface of a PMMA (polymethylmethpolyacrylate) sheet; A polyurethane reaction system was sprayed, by flow rate of 2.5 L/min, onto the PMMA sheet by Unipre CP54 to foam and form a polyurethane layer, wherein the components of the polyurethane reaction system were listed as following:

| | | |
|---|---|---|
| Multitec ® TP.PU. 20MT08 | 50 | wt. % |
| Multitec ® TP.PU. 20 MT11 | 50 | wt. % |
| Multitec ® TP.PU. 10MT03 | 140.4 | wt. %□ |

The polyurethane layer had been solidified on the PMMA sheet for 7 days to obtain a composite material.

The testing results were listed in Table 1.

### Example 2

A P-15-200# sand paper was used to sand the surface of a PMMA sheet;

A dry cloth was used to rub the surface of the sanded PMMA sheet;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 1.

### Example 3

5 wt. % A-187 and 95 wt. % IPA (isopropanol) were mixed to obtain an epoxy silane solution;

A dry cloth was used to rub the surface of a PMMA sheet;

A soft cloth dipped with epoxy silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 1.

### Example 4

5 wt. % A-Link 597 and 95 wt. % IPA (isopropanol) were mixed to obtain an isocyanurate silane solution;

A dry cloth was used to rub the surface of a PMMA sheet;

A soft cloth dipped with isocyanurate silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 1.

### Example 5

A P-15-200# sand paper was used to sand the surface of a PMMA sheet;

A dry cloth was used to rub the surface of the sanded PMMA sheet;

A soft cloth dipped with 5 wt. % A-Link 597 isocyanurate silane solution mentioned in Example 4 was used to rub the surface of the PMMA sheet, thereafter, the PMMA sheet had been air dried for 20 minutes;

The polyurethane layer had been solidified on the PMMA sheet for 7 days to obtain a composite material.

The testing results were listed in Table 1.

TABLE 1

| | Not sanded | | | Sanded | |
|---|---|---|---|---|---|
| | Not | Pretreated by | Pretreated by | Not | |
| | pretreated | 5 wt. % | 5% | pretreated | Pretreated by 5% |
| | by saline | A-187 | A-Link 597 | by saline | A-Link 597 |
| Example | 1 | 3 | 4 | 2 | 5 |
| Adhesion strength (N) | 88 | 299 | 702 | 545 | 1116 |
| Cohesion failure | 0 | 90 | 100 | 0 | 100 |
| percentage (%) | | | | | |

Conclusion from Example 1-5

The polyurethane reaction system was sprayed onto the surface of the PMMA sheet pretreated by epoxy silane (5 wt. % A-187) to obtain a composite material comprising the polyacrylate layer and the polyurethane layer, wherein the cohesion failure percentage between the polyacrylate layer and the polyurethane layer was significantly improved.

The polyurethane reaction system was sprayed onto the surface of the PMMA sheet pretreated by isocyanurate silane (5 wt. % A-Link 597) to obtain a composite material comprising the polyacrylate layer and the polyurethane layer, wherein not only the cohesion failure percentage but also the adhesion strength between the polyacrylate layer and the polyurethane layer was significantly improved.

In addition, the preparing process of the composite material could further include a sanding process, the sanding process could further improve the adhesion strength and the cohesion failure percentage between the polyacrylate layer and the polyurethane layer.

### Example 6

5 wt. % A-189 and 95 wt. % IPA (isopropanol) were mixed to obtain a silane solution;

A dry cloth was used to rub the surface of the sanded PMMA sheet;

A soft cloth dipped with the silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 2.

### Example 7

5 wt. % A-1100 and 95 wt. % IPA (isopropanol) were mixed to obtain a silane solution;

A dry cloth was used to rub the surface of the sanded PMMA sheet;

A soft cloth dipped with the silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 2.

### Example 8

5 wt. % A-1524 and 95 wt. % IPA (isopropanol) were mixed to obtain a silane solution;

A dry cloth was used to rub the surface of the sanded PMMA sheet;

A soft cloth dipped with the silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 2.

### Example 9

5 wt. % A-174 and 95 wt. % IPA (isopropanol) were mixed to obtain a silane solution;

A dry cloth was used to rub the surface of the sanded PMMA sheet;

A soft cloth dipped with the silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 2.

### Example 10

5 wt. % A-171 and 95 wt. % IPA (isopropanol) were mixed to obtain a silane solution;

A dry cloth was used to rub the surface of the sanded PMMA sheet;

A soft cloth dipped with the silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 2.

### Example 11

0.5 wt. % A-Link 597 and 99.5 wt. % IPA (isopropanol) were mixed to obtain a silane solution;

A dry cloth was used to rub the surface of the sanded PMMA sheet;

A soft cloth dipped with the silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 2.

### Example 12

10 wt. % A-Link 597 and 90 wt. % IPA (isopropanol) were mixed to obtain a silane solution;

A dry cloth was used to rub the surface of the sanded PMMA sheet;

A soft cloth dipped with the silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 2.

### Example 13

0.5 wt. % A-187 and 99.5 wt. % IPA (isopropanol) were mixed to obtain a silane solution;

A dry cloth was used to rub the surface of the sanded PMMA sheet;

A soft cloth dipped with the silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 2.

### Example 14

20 wt. % A-187 and 80 wt. % IPA (isopropanol) were mixed to obtain a silane solution;

A dry cloth was used to rub the surface of the sanded PMMA sheet;

A soft cloth dipped with the silane solution was used to rub the surface of the PMMA sheet, thereafter, the PMMA sheet had been air dried for 20 minutes;

A polyurethane reaction system was sprayed, by flow rate of 2.5 L/min, onto the PMMA sheet by a Unipre CP54 to foam and form a polyurethane layer, wherein the components of the polyurethane reaction system were as same as the components listed in Example 1;

The polyurethane layer had been solidified on the PMMA sheet for 7 days to obtain a composite material.

The testing results were listed in Table 2.

TABLE 2

| | Example | | | | | | | | | |
|---|---|---|---|---|---|---|---|---|---|---|
| | 1 | 6 | 7 | 8 | 9 | 10 | 11 | 12 | 13 | 14 |
| Silane | — | 5% | 5% | 5% | 5% | 5% | 0.5% | 10% | 0.5% | 20% |
| solution | | A-189 | A-1100 | A-1524 | A-174 | A-171 | A-Link 597 | A-Link 597 | A-187 | A-187 |
| Adhesion | 88 | 466 | 314 | 402 | 964 | 307 | 625 | 712 | 240 | 1107 |
| strength (N) | | | | | | | | | | |

Conclusion from Example 1 and Example 6-14:

After being pretreated by silane solution, in the composite material, the adhesion strength between the polyacrylate layer and the polyurethane layer was improved in different degrees. Either the low concentration of the methyl propylene acyloxy propyl trimethoxyl silane (5 wt. % A-174), isocyanurate silane solution (0.5-10 wt. % A-Link 597), or the high concentration of the epoxy silane solution (20 wt. % A-187) could significantly improve the adhesion strength between the polyacrylate layer and the polyurethane layer.

Although the present invention is illustrated through Examples, it is not limited by these Examples in any way. Without departing from the spirit and scope of this invention, those skilled in the art can make any modifications and alternatives. And the protection of this invention is based on the scope defined by the claims of this application.

1.-16. (canceled)

17. A composite material comprising a polyacrylate layer, a polyurethane layer and a silane layer disposed between the polyacrylate layer and the polyurethane layer.

18. The composite material according to claim 17, wherein the silane layer comprises a silane having a general formula of Y—R—Si-MeₙX₃₋ₙ, where,
Y represents a substituent selected from the group consisting of an isocyanurate group, methacryloxy group and epoxy group;
R represents an alkyl group comprising 1-5 carbon atoms;
Me is methyl;
n is an integer from 1-3; and
X represents a substituent selected from the group consisting of methoxy (OCH₃), ethoxy (OC₂H₅), isopropoxide (OCH₂(CH₃)₂) and 2-methoxyethoxy (OCH₃OC₂H₄).

19. The composite material according to claim 17, wherein the silane layer comprises a silane selected from the group consisting of tri-((3-trimethoxy silicon) propyl) isocyanurate, tri-((3-triethoxy silicon) propyl) isocyanurate, γ-methacryloxy propyl trimethoxy silane, γ-methacryloxy propyl methyl dimethoxy silane, γ-methacryloxy propyl triethoxy silane, γ-methacryloxy propyl methyl diethoxy silane, γ-methacryloxy propyl triisopropoxide silane, methacryloxy propyl tri(2-methoxyethoxy) silane, γ-glycidoxypropyl trimethoxy silane, γ-glycidoxypropyl triethoxy silane, γ-glycidoxypropyl triisopropoxide silane, γ-glycidoxypropyl methyl dimethoxy silane, γ-glycidoxypropyl methyl diethoxy silane, β-(3,4-epoxy cyclohexyl)ethyl trimethoxy silane and β-(3,4-epoxy cyclohexyl)ethyl triethoxy silane.

20. The composite material according to claim 17, wherein the polyacrylate layer comprises a component selected from the group consisting of polymethyl methacrylate, poly ethyl methacrylate, poly butyl methacrylate, polymethyl acrylate, polyethylene acrylate, polybutyl acrylate, and combinations thereof.

21. The composite material according to claim 17, wherein the polyurethane layer comprises polyether polyurethane, polyester polyurethane, polyolefin polyurethane, or combinations thereof.

22. A method for preparing a composite material, comprising:
a) applying a silane layer onto a surface of a polyacrylate layer; and
b) applying a polyurethane reaction system onto the exposed surface the silane layer to form a polyurethane layer such that the silane layer is positioned between the polyacrylate layer and the polyurethane layer.

23. The method according to claim 22, wherein, the silane layer comprises a silane having a general formula of Y—R—Si-MeₙX₃₋ₙ, where,
Y represents a substituent selected from the group consisting of an isocyanurate group, methacryloxy group and epoxy group;
R represents an alkyl group comprising 1-5 carbon atoms;
Me is methyl;
n is an integer from 1-3; and
X represents a substituent selected from the group consisting of methoxy (OCH₃), ethoxy (OC₂H₅), isopropoxide (OCH₂(CH₃)₂) and 2-methoxyethoxy (OCH₃OC₂H₄).

24. The method according to claim 22, wherein the silane layer is formed by spreading a silane solution, wherein the solute of the silane solution comprises one or more silanes having a general formula of Y—R—Si-MeₙX₃₋ₙ, where,
Y represents a substituent selected from the group consisting of an isocyanurate group, methacryloxy group and epoxy group;
R represents an alkyl group comprising 1-5 carbon atoms;
Me is methyl;
n is an integer from 1-3; and
X represents a substituent selected from the group consisting of methoxy (OCH₃), ethoxy (OC₂H₅), isopropoxide (OCH₂(CH₃)₂) and 2-methoxyethoxy (OCH₃OC₂H₄); and
the solvent of the silane solution is an alcoholic solvent, a ketone solvent or an ester solvent.

25. The method according to claim 24, wherein the concentration of the silane solution is 0.5-20 wt. %, based on 100 wt. % of the silane solution.

26. The method according to claim 22, wherein the silane layer comprises a silane selected from the group consisting of tri-((3-trimethoxy silicon) propyl) isocyanurate, tri((3-triethoxy silicon) propyl) isocyanurate, γ-methacryloxy propyl trimethoxy silane, γ-methacryloxy propyl methyl dimethoxy silane, γ-methacryloxy propyl triethoxy silane, γ-methacryloxy propyl methyl diethoxy silane, γ-methacryloxy propyl triisopropoxide silane, methacryloxy propyl tri(2-methoxyethoxy) silane, γ-glycidoxypropyl trimethoxy silane, γ-glycidoxypropyl triethoxy silane, γ-glycidoxypropyl triisopropoxide silane, γ-glycidoxypropyl methyl dimethoxy silane, γ-glycidoxypropyl methyl diethoxy silane, β-(3,4-epoxy cyclohexyl)ethyl trimethoxy silane and β-(3,4-epoxy cyclohexyl)ethyl triethoxy silane.

27. The method according to claim 22, wherein the polyacrylate layer comprises a polyacrylate selected from the group consisting of polymethyl methacrylate, poly ethyl methacrylate, poly butyl methacrylate, polymethyl acrylate, polyethylene acrylate, poly butylacrylate, and combinations thereof.

28. The method according to claim 22, wherein the polyurethane layer comprises a polyurethane selected from the group consisting of polyether polyurethane, polyester polyurethane, polyolefin polyurethane, and combinations thereof.

29. The method according to claim 23, wherein the silane is applied onto the surface of the polyacrylate layer to form the silane layer by spraying, brush coating or wiping.

30. The method according to claim 24, wherein the silane solution is applied onto the surface of the polyacrylate layer to form the silane layer by spraying, brush coating, or wiping.

31. The method as claimed in claim 22, wherein the polyurethane reaction system is applied by being sprayed onto the surface of the polyacrylate layer with the silane layer applied thereon to form the polyurethane layer.

32. A bath product, automobile part, ship part, sport equipment, spaceflight part or aviation part comprising the composite material according to claim 17.
